(19) United States
(12) Patent Application Publication
(10) Pub. No.: US 2021/0350103 A1
(43) Pub. Date: Nov. 11, 2021

(54) DISPLAY DEVICE WITH SCREEN FINGERPRINT RECONGNITION FUNCTION AND ELECTRONIC DEVICE

(71) Applicant: Wuhan China Star Optoelectronics Semiconductor Display Technology Co., Ltd., Wuhan (CN)

(72) Inventor: Yexi SUN, Wuhan (CN)

(21) Appl. No.: 16/479,598

(22) PCT Filed: Mar. 14, 2019
(86) PCT No.: PCT/CN2019/078099

§ 371 Date: Jul. 21, 2019

(30) Foreign Application Priority Data
Dec. 6, 2018 (CN) 201811486483.5

(51) Int. Cl. G06K 9/00; G06K 9/20; G09G 3/3225; G06F 21/32

(52) U.S. Cl. CPC G06K 9/0004; G06K 9/00053; G06K 9/209; H01L 27/3244; G09G 3/3225; G06F 21/32; G09G 2320/046; G06K 9/2027

(57) ABSTRACT

The present disclosure provides a display device with a screen fingerprint recognition function, including a light sensing layer configured to sense a fingerprint, a light source layer disposed on the light sensing layer and configured to generate light, and an image display module disposed on the light source layer and configured to generate light to display an image. The present disclosure further provides an electronic device including the display device.

### FIELD OF INVENTION

The present disclosure relates to a display device, and particularly to a display device with a screen fingerprint recognition function and an electronic device comprising the same.

### BACKGROUND

A display device with a screen fingerprint recognition function is a popular product in the field of small-sized display devices in recent years. Advantages of the screen fingerprint recognition function are maximization of a display area of a screen of the display device and an increased screen ratio, so that a user can have a better visual experience.

At present, mainstream screen fingerprint recognition technology is that an optical signal emitted by a screen of a display device is reflected by a fingerprint and reaches a light sensor below a fingerprint recognition area, and then the light sensor transmits corresponding fingerprint information to a processor, thereby unlocking a screen. However, due to a service life limitation of organic light emitting diode (OLED) luminescent materials, brightness of the optical signal generated by the screen cannot be too high. Therefore, the optical signal reaching the light sensor for fingerprint recognition is weak, so that the success rate and accuracy of fingerprint recognition are significantly reduced. Furthermore, OLED devices on the fingerprint recognition area are at risk of burning the screen.

Therefore, there is a need to propose a solution to the problems in the prior art.

### SUMMARY OF DISCLOSURE

The purpose of the present disclosure is to provide a display device with a screen fingerprint recognition function and an electronic device comprising the same in order to solve the problem, in the prior art, that the success rate and accuracy of fingerprint recognition are significantly reduced.

To solve the aforementioned problem, the present disclosure provides a display device with a screen fingerprint recognition function comprising: a light sensing layer configured to sense a fingerprint, a light source layer disposed on the light sensing layer and configured to generate light, an image display module disposed on the light source layer and configured to generate light to display an image, and an anti-interference layer disposed on the image display module and configured to prevent ambient light interference; wherein the light source layer comprises an infrared light source, and the light sensing layer comprises an infrared light receiver.

In an embodiment of the present disclosure, the display device with a screen fingerprint recognition function further comprises: a cover plate disposed on the anti-interference layer and configured to protect the light sensing layer, the light source layer, the image display module, and the anti-interference layer.

In an embodiment of the present disclosure, the anti-interference layer is a polarizer.

In an embodiment of the present disclosure, the image display module comprises: a substrate disposed on the light source layer, a thin film transistor layer disposed on the substrate, and an organic light emitting diode layer disposed on the thin film transistor layer and configured to emit light to display an image in response to a control of the thin film transistor layer.

In an embodiment of the present disclosure, when the screen fingerprint recognition function is turned on, the light source layer generates light, and then the light generated by the light source layer and the light generated by the image display module reaches the fingerprint, and then the light reflected by the fingerprint reaches the light sensing layer as a light signal, and then the light signal sensed by the light sensing layer is transmitted to a control module of the display device, and then the control module unlocks the screen of the display device by recognizing the optical signal.

To solve the aforementioned problem, the present disclosure further provides a display device with a screen fingerprint recognition function comprising: a light sensing layer configured to sense a fingerprint, a light source layer disposed on the light sensing layer and configured to generate light, and an image display module disposed on the light source layer and configured to generate light to display an image.

According to an embodiment of the present disclosure, the display device with a screen fingerprint recognition function further comprises: a cover plate disposed on the anti-interference layer and configured to protect the light sensing layer, the light source layer, and the image display module.

According to an embodiment of the present disclosure, the display device with a screen fingerprint recognition function further comprises: an anti-interference layer disposed on the image display module and configured to prevent ambient light interference.

According to an embodiment of the present disclosure, the display device with a screen fingerprint recognition function further comprises: a cover plate disposed on the anti-interference layer and configured to protect the light sensing layer, the light source layer, the image display module, and the anti-interference layer.

According to an embodiment of the present disclosure, the anti-interference layer is a polarizer.

In an embodiment of the present disclosure, the image display module comprises: a substrate disposed on the light source layer, a thin film transistor layer disposed on the substrate, and an organic light emitting diode layer disposed on the thin film transistor layer and configured to emit light to display an image in response to a control of the thin film transistor layer.

According to an embodiment of the present disclosure, when the screen fingerprint recognition function is turned on, the light source layer generates light, and then the light generated by the light source layer and the light generated by the image display module reaches the fingerprint, and then the light reflected by the fingerprint reaches the light sensing layer as a light signal, and then the light signal sensed by the light sensing layer is transmitted to a control module of the display device, and then the control module unlocks the screen of the display device by recognizing the optical signal.

The present disclosure further provides an electronic device, comprising a display device with a screen fingerprint recognition function, wherein the display device with a screen fingerprint recognition function comprises: a light sensing layer configured to sense a fingerprint, a light source layer disposed on the light sensing layer and configured to generate light, and an image display module disposed on the light source layer and configured to generate light to display an image.

According to an embodiment of the present disclosure, the display device with a screen fingerprint recognition function further comprises: an anti-interference layer disposed on the image display module and configured to prevent ambient light interference

According to an embodiment of the present disclosure, when the screen fingerprint recognition function is turned on, the light source layer generates light, and then the light generated by the light source layer and the light generated by the image display module reaches the fingerprint, and then the light reflected by the fingerprint reaches the light sensing layer as a light signal, and then the light signal sensed by the light sensing layer is transmitted to a control module of the display device, and then the control module unlocks the screen of the display device by recognizing the optical signal.

Compared with the prior art, the display device with a screen fingerprint recognition function of the present disclosure and the electronic device comprising the same are provided with the light source layer between the light sensing layer and the image display module, thereby increasing the light reaching the fingerprint, and then increasing the light reflected by the fingerprint, and further improving the accuracy of fingerprint recognition. Furthermore, since the light source layer can reduce the light provided by the organic light emitting diode layer of the image display module for fingerprint recognition, the risk of burning the screen can be reduced.

### BRIEF DESCRIPTION OF DRAWINGS

FIG. 1 shows a display device with a screen fingerprint recognition function according to an embodiment of the present disclosure.

FIG. 2 is a schematic diagram showing the fingerprint recognition of the display device with the screen fingerprint recognition function of FIG. 1.

FIG. 3 shows a display device with a screen fingerprint recognition function according to another embodiment of the present disclosure.

FIG. 4 shows an electronic device according to an embodiment of the present disclosure.

### DETAILED DESCRIPTION

The following description of various embodiments of the present invention, in conjunction with accompanying drawings, is intended to illustrate specific implementable embodiments of the present disclosure.

Please refer to FIG. 1, which shows a display device with a screen fingerprint recognition function according to an embodiment of the present disclosure.

The display device is an organic light emitting diode (OLED) display device.

The display device comprises a light sensing layer 10, a light source layer 20, an image display module 30, and a cover plate 40.

The light sensing layer 10 comprises one or more light sensors and configured to sense a fingerprint.

The light source layer 20 is disposed on the light sensing layer 10 and configured to generate light.

The image display module 30 is disposed on the light source layer 20 and configured to generate light to display an image.

In a non-limiting embodiment, the light source layer 20 comprises an infrared light source, and the light sensing layer 10 comprises an infrared light receiver.

The cover plate 40 is disposed on the image display module 30 and configured to protect the light sensing layer 10, the light source layer 20, and the image display module 30.

A feature of the present disclosure is that the light source layer 20 is disposed between the light sensing layer 10 and the image display module 30, and the light generated by the light source layer 20 can increase the light reaching a fingerprint, thereby increasing the light reflected by the fingerprint, and further improving the accuracy of fingerprint recognition.

The image display module 30 comprises a substrate 300, a thin film transistor layer 302, and an organic light emitting diode layer 304.

The substrate 300 is disposed on the light source layer 20 and used as a supporting substrate for the thin film transistor layer 302 and the organic light emitting diode layer 304.

The thin film transistor layer 302 is disposed on the substrate 300 and used for signal transmission. The thin film transistor layer 302 comprises a plurality of thin film transistors.

The organic light emitting diode layer 304 is disposed on the thin film transistor layer 302 and configured to emit light to display the image in response to a control of the thin film transistor layer 302. The organic light emitting diode layer 304 comprises a plurality of organic light emitting diodes. The plurality of organic light emitting diodes can display colored light.

It should be noted that the display principle of the image display module 30 is well known to those skilled in the art, and will not be further described herein.

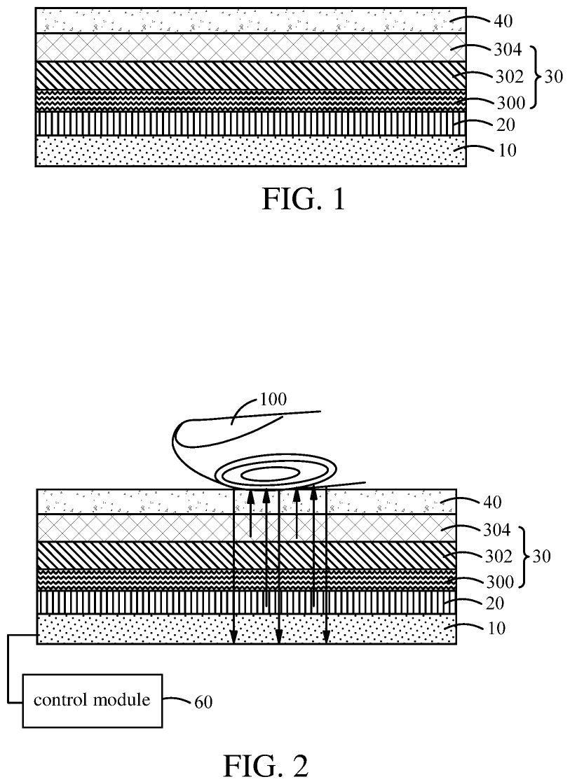

Please refer to FIG. 1 and FIG. 2. FIG. 2 is a schematic diagram showing the fingerprint recognition of the display device with the screen fingerprint recognition function of FIG. 1.

When the screen fingerprint recognition function of the display device is turned on, the light source layer 20 generates light, and then the light generated by the light source layer 20 and the light generated by the image display module 30 (the organic light emitting diode layer 304) reach a fingerprint 100, and then the light reflected by the fingerprint 100 reaches the light sensing layer 10 as a light signal, and then the light signal sensed by the light sensing layer 10 is transmitted to a control module 60 of the display device, and then the control module 60 unlocks the screen of the display device by recognizing the light signal.

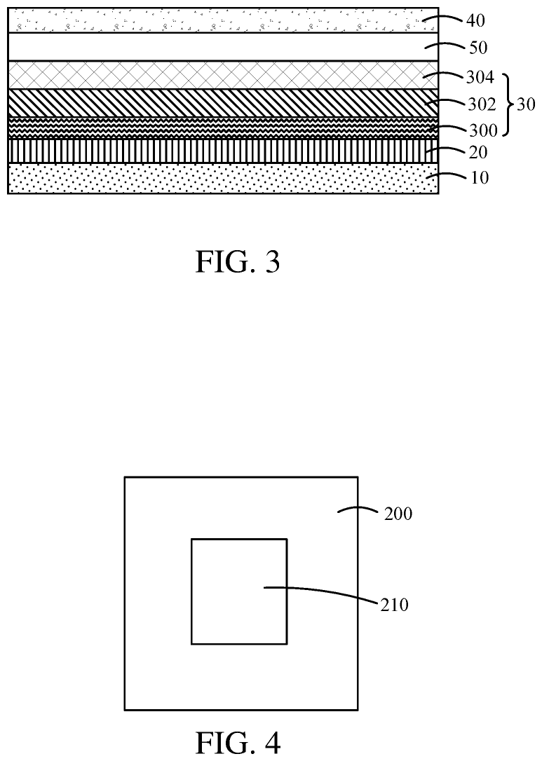

Please refer to FIG. 3, which shows a display device with a screen fingerprint recognition function according to another embodiment of the present disclosure.

The display device is an organic light emitting diode (OLED) display device.

The display device comprises a light sensing layer 10, a light source layer 20, an image display module 30, an anti-interference layer 50, and a cover plate 40.

The light sensing layer 10 comprises one or more light sensors and configured to sense a fingerprint.

The light source layer 20 is disposed on the light sensing layer 10 and configured to generate light.

The image display module 30 is disposed on the light source layer 20 and configured to generate light to display an image.

The display device of this embodiment differs from the display device of the embodiment shown in FIG. 1 in that the display device of this embodiment further comprises the anti-interference layer 50. The anti-interference layer 50 is disposed on the image display module 30 and configured to prevent ambient light interference. More specifically, the anti-interference layer 50 is disposed between the image display module 30 and the cover plate 40.

It is to be noted that the anti-interference layer 50 is an optional component. In an embodiment, the anti-interference layer 50 may be a polarizer.

The cover plate 40 is disposed on the anti-interference layer 50 and configured to protect the light sensing layer 10, the light source layer 20, the image display module 30, and the anti-interference layer 50.

A feature of the present disclosure is that the light source layer 20 is disposed between the light sensing layer 10 and the image display module 30, and the light generated by the light source layer 20 can increase the light reaching a fingerprint, thereby increasing the light reflected by the fingerprint, and further improving the accuracy of fingerprint recognition.

The image display module 30 comprises a substrate 300, a thin film transistor layer 302, and an organic light emitting diode layer 304.

The substrate 300 is disposed on the light source layer 20 and used as a supporting substrate for the thin film transistor layer 302 and the organic light emitting diode layer 304.

The thin film transistor layer 302 is disposed on the substrate 300 and used for signal transmission. The thin film transistor layer 302 comprises a plurality of thin film transistors.

The organic light emitting diode layer 304 is disposed on the thin film transistor layer 302 and configured to emit light to display the image in response to a control of the thin film transistor layer 302. The organic light emitting diode layer 304 comprises a plurality of organic light emitting diodes. The plurality of organic light emitting diodes can display colored light.

It should be noted that the display principle of the image display module 30 is well known to those skilled in the art, and will not be further described herein.

For the principle of fingerprint recognition of the display device shown in FIG. 3, reference may be made to the related description of FIG. 2, and details are not described herein again.

Please refer to FIG. 4, which shows an electronic device 200 according to an embodiment of the present disclosure.

The electronic device 200 comprises a display device 210 with a screen fingerprint recognition function shown in FIG. 1 or FIG. 2.

For the structure and the principle of fingerprint recognition of the display device 210 with a screen fingerprint recognition function, reference may be made to the related descriptions of FIG. 1 to FIG. 3, and details are not described herein again.

The display device with a screen fingerprint recognition function of the present disclosure and the electronic device comprising the same are provided with the light source layer between the light sensing layer and the image display module, thereby increasing the light reaching the fingerprint, and then increasing the light reflected by the fingerprint, and further improving the accuracy of fingerprint recognition. Furthermore, because the light source layer can reduce the light provided by the organic light emitting diode layer of the image display module for fingerprint recognition, the risk of burning the screen can be reduced.

In the above, the present disclosure has been disclosed in the above preferred embodiments, but the preferred embodiments are not intended to limit the present disclosure, and those skilled in the art may make various modifications without departing from the scope of the present disclosure. The protective scope of the present disclosure is determined by the claims.

What is claimed is:

1. A display device with a screen fingerprint recognition function, comprising:
a light sensing layer configured to sense a fingerprint;
a light source layer, disposed on the light sensing layer, configured to generate light;
an image display module, disposed on the light source layer, configured to generate light to display an image; and
an anti-interference layer, disposed on the image display module, configured to prevent ambient light interference;
wherein the light source layer comprises an infrared light source, and the light sensing layer comprises an infrared light receiver.

2. The display device with the screen fingerprint recognition function according to claim 1, further comprising:
a cover plate, disposed on the anti-interference layer, configured to protect the light sensing layer, the light source layer, the image display module, and the anti-interference layer.

3. The display device with the screen fingerprint recognition function according to claim 1, wherein the anti-interference layer is a polarizer.

4. The display device with the screen fingerprint recognition function according to claim 1, wherein the image display module comprises:
a substrate disposed on the light source layer;
a thin film transistor layer disposed on the substrate; and
an organic light emitting diode layer, disposed on the thin film transistor layer, configured to emit light to display an image in response to a control of the thin film transistor layer.

5. The display device with the screen fingerprint recognition function according to claim 1, wherein when the screen fingerprint recognition function is turned on, the light source layer generates light, and then the light generated by the light source layer and the light generated by the image display module reach the fingerprint, and then the light reflected by the fingerprint reaches the light sensing layer as a light signal, and then the light signal sensed by the light sensing layer is transmitted to a control module of the display device, and then the control module unlocks the screen of the display device by recognizing the light signal.

6. A display device with a screen fingerprint recognition function, comprising:
a light sensing layer configured to sense a fingerprint;
a light source layer, disposed on the light sensing layer, configured to generate light; and
an image display module, disposed on the light source layer, configured to generate light to display an image.

7. The display device with the screen fingerprint recognition function according to claim 6, further comprising:
a cover plate, disposed on the anti-interference layer, configured to protect the light sensing layer, the light source layer, and the image display module.

8. The display device with the screen fingerprint recognition function according to claim 6, further comprising:
an anti-interference layer, disposed on the image display module, configured to prevent ambient light interference.

9. The display device with the screen fingerprint recognition function according to claim 8, further comprising:
a cover plate, disposed on the anti-interference layer, configured to protect the light sensing layer, the light source layer, the image display module, and the anti-interference layer.

10. The display device with the screen fingerprint recognition function according to claim 8, wherein the anti-interference layer is a polarizer.

11. The display device with the screen fingerprint recognition function according to claim 6, wherein the image display module comprises:
a substrate disposed on the light source layer;
a thin film transistor layer disposed on the substrate; and
an organic light emitting diode layer, disposed on the thin film transistor layer, configured to emit light to display an image in response to a control of the thin film transistor layer.

12. The display device with the screen fingerprint recognition function according to claim 6, wherein when the screen fingerprint recognition function is turned on, the light source layer generates light, and then the light generated by the light source layer and the light generated by the image display module reach the fingerprint, and then the light reflected by the fingerprint reaches the light sensing layer as a light signal, and then the light signal sensed by the light sensing layer is transmitted to a control module of the display device, and then the control module unlocks the screen of the display device by recognizing the light signal.

13. An electronic device, comprising a display device with a screen fingerprint recognition function, wherein the display device with the screen fingerprint recognition function comprises:
a light sensing layer configured to sense a fingerprint;
a light source layer, disposed on the light sensing layer, configured to generate light; and
an image display module, disposed on the light source layer, configured to generate light to display an image.

14. The electronic device according to claim 13, wherein the display device with the screen fingerprint recognition function further comprises:
an anti-interference layer, disposed on the image display module, configured to prevent ambient light interference.

15. The electronic device according to claim 13, wherein when the screen fingerprint recognition function of the display device is turned on, the light source layer generates light, and then the light generated by the light source layer and the light generated by the image display module reach the fingerprint, and then the light reflected by the fingerprint reaches the light sensing layer as a light signal, and then the light signal sensed by the light sensing layer is transmitted to a control module of the display device, and then the control module unlocks the screen of the display device by recognizing the light signal.
